(19) United States
(12) Patent Application Publication
(10) Pub. No.: US 2014/0209620 A1
(43) Pub. Date: Jul. 31, 2014

(54) Drain Nut

(71) Applicant: Kyle Steven Barna, Syracuse, NY (US)

(72) Inventor: Kyle Steven Barna, Syracuse, NY (US)

(21) Appl. No.: 13/755,740

(22) Filed: Jan. 31, 2013

(51) Int. Cl. F16T 1/00

(52) U.S. Cl. CPC F16T 1/00
USPC 220/694

(57) ABSTRACT

A drain device can include a drain body, a drain nut, and a retaining member. The drain body can include at least one wall forming a cavity, where the at least one wall traverses an aperture in the enclosure, and where the drain body has a top end positioned inside the enclosure and a bottom end positioned outside the enclosure. The drain nut can be mechanically coupled to the drain body and can include a number of extending members extending substantially radially away from the top end of the drain body. Each extending member can have a distal end and a proximal end mechanically coupled to the top end of the drain body. Each extending member can have a length that is greater than a width of the proximal end. The retaining member can be mechanically coupled to the bottom end of the drain body.

### TECHNICAL FIELD

The present disclosure relates generally to drain devices and more particularly to systems, methods, and devices for draining fluids from within an enclosure.

### BACKGROUND

Enclosures that contain electrical equipment often have issues with condensation and moisture forming inside the enclosure. Such condensation and moisture can enter the enclosure through a conduit connection, an inadequate seal around the door to the enclosure, an aperture that lacks a proper covering and/or seal, some other aspect of the enclosure, or any combination thereof. Removing the condensation and moisture is important to maintaining the integrity of, and for prolonging the useful life of, a number of electrical components. Such components can include, but are not limited to conductors, relays, sensors, controllers, and pushbuttons.

### SUMMARY

In general, in one aspect, the disclosure relates to a drain device for an enclosure. The drain device can include a drain body having at least one wall forming a cavity, where the at least one wall traverses an aperture in the enclosure, and where the drain body has a top end positioned inside the enclosure and a bottom end positioned outside the enclosure. The drain device can also include a drain nut mechanically coupled to the top end of the drain body. The drain nut can include a number of extending members extending substantially radially away from the top end of the drain body. Each extending member can have a distal end and a proximal end mechanically coupled to the top end of the drain body. Also, each extending member can have a length that is greater than a width of the proximal end. The drain device can further include a retaining member mechanically coupled to the bottom end of the drain body.

In another aspect, the disclosure can generally relate to an enclosure. The enclosure can include an enclosure wall having an aperture that traverses therethrough, where the enclosure wall separates an interior region and an exterior region. The enclosure can also include a drain device traversing the aperture and mechanically coupled to the enclosure wall. The drain device of the enclosure can include a drain body having at least one wall forming a cavity, where the at least one wall traverses the aperture in the enclosure, and where the drain body has a top end positioned in the interior region and a bottom end positioned in the exterior region. The drain device of the enclosure can also include a drain nut mechanically coupled to the top end of the drain body in the interior region. The drain nut of the drain device can include a number of extending members extending substantially radially away from the top end of the drain body. Each extending member can have a distal end and a proximal end mechanically coupled to the top end of the drain body. Also, each extending member has a length that is greater than a width of the proximal end. The drain device of the enclosure can further include a retaining member mechanically coupled to the bottom end of the drain body in the exterior region.

In yet another aspect, the disclosure can generally relate to an adaptive drain nut. The adaptive drain nut can include a number of extending members arranged adjacent to each other in a geometric shape. Each extending member can have a proximal end mechanically coupled to at least one feature of an existing drain device. Each extending member can have a length that is greater than a width of the proximal end. The existing drain device can be mechanically coupled to an enclosure through an aperture in an enclosure wall

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIGS. 1A and 1B show various views of an example drain device that includes an example drain nut in accordance with certain example embodiments.

FIGS. 2A and 2B show various views of an enclosure using the example drain nut of FIGS. 1A and 1B in accordance with certain example embodiments.

FIGS. 3A and 3B show various views of another example drain nut in accordance with certain example embodiments.

### DETAILED DESCRIPTION

Example embodiments of drain nuts will now be described in detail with reference to the accompanying figures. Like, but not necessarily the same or identical, elements in the various figures axe denoted by like reference numerals for consistency. In the following detailed description of the example embodiments, numerous specific details are set forth in order to provide a more thorough understanding of the disclosure herein. However, it will be apparent to one of ordinary skill in the art that the example embodiments herein may be practiced without these specific details. In other instances, well-known features have not been described in detail to avoid unnecessarily complicating the description. Further, certain descriptions (e.g., top, bottom, side, end, interior, inside, inner, outer) are merely intended to help clarify aspects and are not meant to limit embodiments described herein.

In general, example embodiments provide systems, methods, and devices for draining moisture and/or condensation from within an enclosure. Specifically, example embodiments provide for a drain nut that collects and disposes of condensation within an enclosure so that the condensation does not accumulate on electrical wiring, metal components, and/or electrical devices. An example drain nut can be positioned within an enclosure.

Further, as used herein, a drain nut can also be an example term used to describe a connector with extending protrusions (described below) that encourage moisture and/or condensation to be collected into an existing or integrated drain in an enclosure. In other words, a drain nut be its own drain device, or an example drain nut can work in cooperation with an existing device in an enclosure.

An enclosure can have one or more openings and/or apertures that traverse one or more wails of the enclosure. For example, one or more conduits enclosing one or more conductors can traverse through the enclosure. Moisture can track within and/or at the coupling point of the conduit to the enclosure. In such a case, an example drain nut can remove at least some of the condensation that accumulates within the enclosure on the one or more conductors.

The example drain nuts described herein can be made of one or more of a number of corrosion-resistant and/or moisture-resistant materials, including but not limited to rubber, nylon, plastic, stainless steel, and polyurethane. The material of the example drain nuts described herein can also be able to withstand extremes in temperature (hot and/or cold), pressures, and other conditions that can be found within an enclosure.

Examples of an enclosure in which an example drain nut can include, but are not limited to, a conduit (rigid or flexible), a junction box, a splice box, a motor control center, a breaker enclosure, a control cabinet, a relay cabinet, an instrumentation panel, a switchgear cabinet, an explosion-proof enclosure, a lighting fixture, and a terminal box. An enclosure can be made of one or more of a number of materials, including but not limited to metal, rubber, and plastic. An enclosure, can be placed in one or more of a number of conditions and/or environments, including but not limited to indoors, outdoors, with exposure to chemicals, with, exposure to heat, with exposure to moisture, in a hazardous location, and in an explosion-proof location.

In certain example embodiments, an enclosure that is mechanically coupled to an example drain nut is subject, to meeting certain standards and/or requirements. For example, an enclosure that mechanically couples to an example drain nut can be placed in one of a number of different environments where one or more standards must be met. Standard setting entities for such enclosures can include, but are not limited to, the National Electrical Manufactures Association (NEMA), the National. Electric Code (NEC), the Institute of Electrical and Electronics Engineers (IEEE), and Underwriters Laboratories (UL).

For example, the example drain nut, when coupled to an enclosure, can allow an enclosure to meet is the NEMA 4X standard. In such a case, the enclosure is constructed to provide a degree of protection against, at least, corrosion, falling dirt, rain, sleet, snow, ice, windblown dust, splashing water, and hose-directed water. Thus, the drain nut that is mechanically coupled to such an enclosure must also meet these standards.

Another standard that the example drain nut, when coupled to an enclosure, allows an enclosure to meet is the NEMA 3R standard. The NEMA 3R standard applies to enclosures for primarily outdoor use, where the enclosure provides protection against falling rain, sleet, and snow. Such an enclosure should also be undamaged by ice that forms on the enclosure. When used indoors, such an enclosure protects against dripping water. A NEMA 3R enclosure does not require a gasket sealing surface.

Yet another standard that the example drain nut, when coupled to an enclosure, allows an enclosure to meet is the NEMA 6P standard. The NEMA 6P standard applies to enclosures for indoor or outdoor use where occasional prolonged submersion of the enclosure in a fluid is encountered. Corrosion protection is required for such an enclosure, and so such enclosures are usually made of stainless steel or plastic.

A user may be any person that interacts with an enclosure, an example drain nut, and/or equipment controlled by one or more components (e.g., motor, fan, relay, programmable logic controller) of the enclosure. Examples of a user may include, but are not limited to, an engineer, an electrician, an instrumentation and controls technician, a mechanic, an operator, a consultant, a contractor, and a manufacturer's representative.

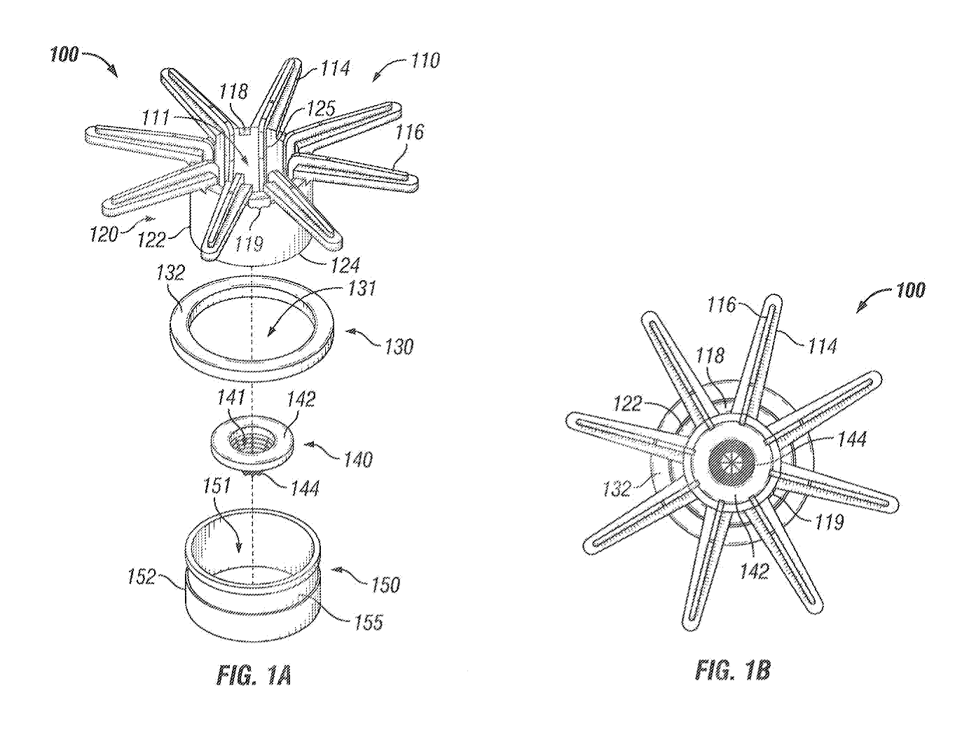

FIGS. 1A and 1B depict various views of an example drain nut 110 integrated with a drain device 100 in accordance with certain example embodiments. Specifically, FIG. 1A shows an exploded perspective view of the drain device 100, including the drain nut 110, FIG. 1B shows a top view of the drain device 100, including the drain nut 110. In one or more embodiments, one or more of the components shown in FIGS. 1A and 1B may be omitted, repeated, and/or substituted. Accordingly, embodiments of drain devices and/or example drain nuts should not be considered limited to the specific arrangements of components shown in FIGS. 1A and 1B.

Referring to FIGS. 1A and 1B, the example drain device 100 includes the drain nut 110, a drain body 120, a retaining member 50, an optional sealing member 130, and an optional drain net 140. The drain body 120 can have at least one drain wall 122 that forms a cavity 111. The drain body has a top end 118 and a bottom end 124. In certain example embodiments, the drain body 120 traverses an aperture in an enclosure. In such a case, the shape of the outer perimeter of the drain wall 122 can be substantially similar to the shape of the aperture in the enclosure. Likewise, the size of the outer perimeter of the drain wall 122 can be slightly smaller than the shape of the aperture in the enclosure. The cross-sectional area (for the inner perimeter and/or the outer perimeter) of the drain body 120 can have one or more of a number of shapes along its length, including but not limited to a circle, an oval, a rectangle, and a hexagon. Similarly, the size of the shape of the cross-sectional area of the drain body 120 can vary along its length. The inner surface and the outer surface of the drain wall 122 can be smooth and/or textured.

The outer surface of the drain wall 122 can have one or more of a number of features. Such features can be for securing the drain body 120 to the enclosure. Examples of such securing features can include, but are not limited to, mating threads, slots, and retractable protrusions. In addition, or in the alternative, the outer surface of the drain wall 122 can include one or more features (e.g., a channel, a recessed area) to secure one or more components (e.g., the sealing member 130) of the drain device 100 to the drain body 120. Similarly, the inner surface of the drain wall 122 can have any of a number of features. For example, the inner surface, of the drain wall 122 can have a number of vertical protrusions 125 to add structural integrity to the drain device 100, where such vertical protrusions 125 can coincide with (or be part of) a raised portion 116 on each extending member 114 of the drain nut 110, as described below. For example, as shown in FIG. 1A, each vertical protrusion 125 disposed on the inner surface of the drain wail 122 of the drain body 120 can be a continuation of the raised portion 116 on each of the plurality of extending members 114.

In certain example embodiments, the top end 118 of the drain body 120 is positioned inside of the enclosure to which the drain device 100 is mechanically coupled. The bottom end 124 of the drain body 120 can be positioned outside of the enclosure. Thus, at least a portion of the drain wall 122 traverses the aperture in the enclosure. The bottom end 124 of the drain body 120 can be mechanically coupled to the retaining member 150. The top end 118 of the drain body 120 can be mechanically coupled to the drain nut 110.

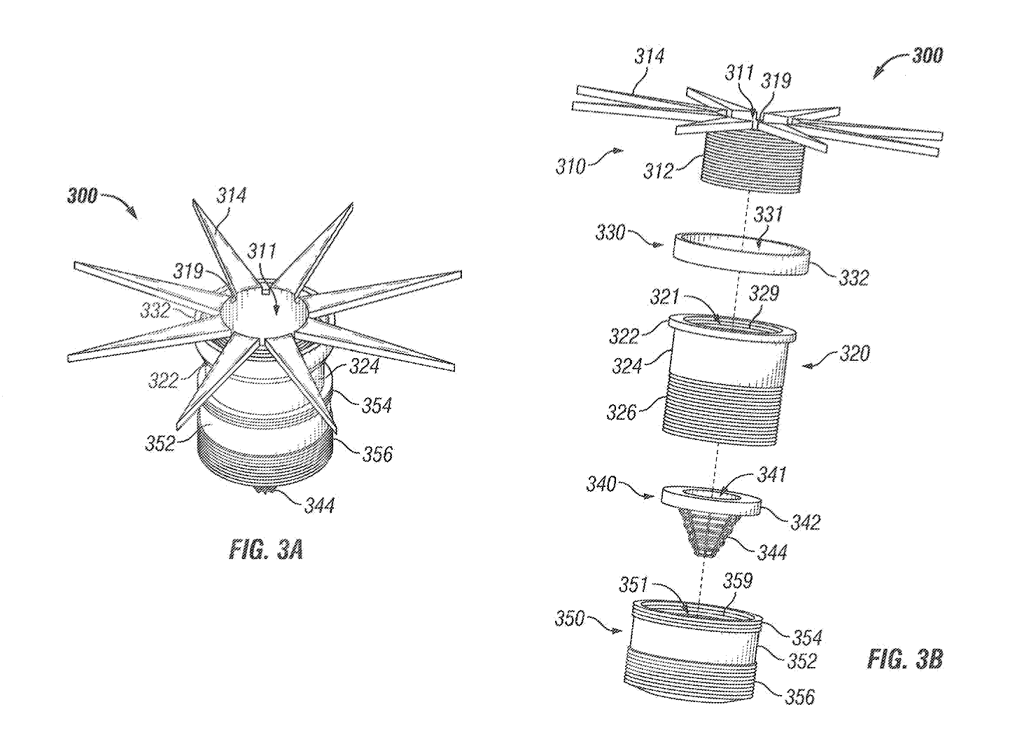

In certain example embodiments, the drain nut 110 is mechanically coupled to the top end 118 of the drain body 120. The drain nut 110 can be removeabiy coupled to the drain body 120 using one or more of a number of coupling features disposed on the drain nut 110 and/or the drain body 120. In such a case, the drain nut 110 can include a neck, as described below with respect to FIGS. 3A and 3B, where the coupling features can be disposed on the neck of the drain nut 110. Such coupling features can include, but are not limited to, mating threads, compression fittings, clips, slots, tabs, recessed areas, and retractable protrusions. A coupling feature disposed on the drain nut 110 can complement a corresponding coupling feature on the drain body 120 when the drain nut 110 is properly oriented with respect to the drain body 120.

Alternatively, the drain nut 110 can be fixedly coupled to the lop end 118 of

the drain body 120. In such a case, the drain nut 110 and the drain body 120 can be made from a single piece, as from a mold. Alternatively, the drain nut 110 can be fixedly coupled to the drain body 120 using, one or more of a number of coupling techniques, including but not limited to welding, soldering, fusion, ultrasonic welding, and epoxy.

The drain nut 110 can. Include one or more extending members 114. In certain example embodiments, each extending member 114 extends radially away from the top end 118 of the drain body 120. In other words, each extending member 114 can extend away from the top end 118 of the drain body 120 so that the bottom surface of the extending member 114 makes contact with, or is positioned very proximate to the top surface of the enclosure adjacent to the aperture through which the chain device 100 is mechanically coupled. Thus, if the top surface of the enclosure is substantially flat and perpendicular to the drain body 120, then the extending members 114 can extend away from the drain, body 120 at approximately a 90° angle.

Each extending member 114 can have a distal end (the end furthest away from the drain body 120) and a proximal end that is mechanically coupled to the top end 118 of the drain body 120. In certain example embodiments, each extending member 114 has a length that is greater than the width of the proximal end of the extending member 114. In addition, the width of the distal end of each extending member 114 can be less than the width of the proximal end of the extending member 114. In other words, the cross-sectional area of the extending member 114 increases in size from the distal end to the proximal end of the extending member 114.

The purpose of the aforementioned configuration of the extending member 114 is to remediate fluids within the enclosure. Specifically, in certain example embodiments, fluids track along the outer surface of the extending member 114 from the distal end toward the proximal end. The shape and configuration of the extending members 114 draws fluids (e.g., water, condensate) into the cavity 111. Specifically, the surface of the extending members 114 encourages hydrogen bonding and a path for the fluids to flow from the distal end of the extending member 114 to the proximal end. The fluids flow from the distal end of the extending member 114 to the proximal end because of the high surface energy of the beading fluid as the fluid accumulates on the extending members 114. The configuration discussed in the previous paragraph is one example of a configuration that allows the fluids to track along the outer surface of the extending member 114 from the distal end toward the proximal end. The outer surface of the extending member 114 can be smooth, be textured, be etched, be channeled, include other features that allow for the tracking of fluids, or any combination thereof.

The distance that an extending member 114 extends from the top end 118 of the drain body 120 (i.e., the length of an extending member 114) can vary. For example, the length of an extending member 114 can be 1 inch. As another example, the length of an extending member 114 can be 2 inches. The length of an extending member 114 can be substantially the same and/or different from the length of the other extending members 114 of the drain nut 120.

The length of the extending members 114 can cause the extending members 114, particularly the distal end, to become vulnerable to external forces (e.g., loosening/lightening the chain nut 120, something falling and/or moving within the enclosure) that can be applied to the extending members 114. To reduce the chance that such external forces can cause the extending members 114 to crack or break, one or more features can be included to the extending members 114 to improve the structural integrity of the extending members 114.

An example of one such feature is a raised portion 116 that is disposed along a portion of the outer surface of the extending member 114. For example, as shown in FIGS. 1A and 1B, the raised portion 116 can protrude (extend upward) from the top surface and/or any other surface (e.g., bottom surface, side surface) of each extending member 114. The raised portion 116 can extend along all or a portion of the length of the extending member 114. The raised portion 116 can be a straight line or have a curvature. An extending member 114 can have more than one raised, portion 116. If there are multiple raised portions, 116, such raised portions 116 can be disposed on the extending member 114 in a regular pattern, randomly, intersect each other, and/or have not intersection with each other. The raised portion 116 and the extending member 114 can be formed from a single piece (as from a mold). Alternatively, the raised portion 116 and the extending member 114 can be mechanically coupled to each other using one or more of a number of coupling techniques, including but not limited to epoxy, pressure fitting, soldering, slotted fittings, and fastening devices. In addition to providing structural support, such features (e.g., the raised portion 116) can provide one or more of a number of other benefits. For example, such features cap help collect fluids and other forms of condensation and allow such fluids and condensation to track toward the proximal end of the extending member 114.

Each extending member 114 can be separated from an adjacent extending member 114 at the proximal end by a gap 119. Each gap 119 can be wide enough to allow the fluids that have tracked along the length of the extending member 114 to continue to the inner surface of the drain wall 122 at the top end 118 of the drain body 120. In addition to the width, the position of the gap 119 can be in a such a location as to encourage transfer of the fluid from the extending members 114 to the inner surface of the drain body 120. For example, the gap 119 can be positioned at such a height with respect to the proximal end of the extending members 114 that the bottom of the gap 119 is on substantially the same plane as the inner surface of the enclosure and/or the top end 118 of the drain body 120.

In certain example embodiments, the retaining member 150 is mechanically coupled to the drain body 120. Specifically, the retaining member 150 can be mechanically coupled to the bottom end 124 of the drain body 120. The retaining feature 150 can include at least one wall 152 that forms a cavity 151. The perimeter of the inner surface of the wall 152 of the retaining feature 150 can have substantially the same shape as the shape of the outer perimeter of the drain wall 122. Likewise, the size of the outer perimeter of the drain wall 122 can be slightly smaller than the perimeter of the inner surface of the wall 152 of the retaining feature 150. The cross-sectional area (for the inner perimeter and/or the outer perimeter) of the retaining member 150 can have one or more of a number of shapes along its length, including but not limited to a circle, an oval, a rectangle, and a hexagon. Similarly, the size of the shape of the cross-sectional area of the retaining member 150 can vary along its length. The inner surface and the outer surface of the wall 152 can be smooth and/or textured.

The inner surface of the wall 152 can have one or more of a number of features. Such features can be for securing the retaining member 150 to the enclosure. Examples of such securing features can include, but are not limited to, mating threads, slots, and retractable protrusions. In addition, or in the alternative, the outer surface of the drain wall 122 can include one or more features (e.g., a channel, a recessed area) to secure one or more components (e.g., the sealing member 130) of the drain device 100 to the retaining member 150, Similarly, the outer surface of the wall 152 can have any of a number of features. For example, the outer surface of the wall 152 can have a recessed channel 155, as shown in FIG. 1A.

In certain example embodiments, the retaining member 150 is removably coupled to the-bottom end 124 of the drain, body 120. In such a ease, the outer surface of the drain wall 122 and/or the inner surface of the retaining member 150 can have one or more of a number of coupling features. Such coupling features can be for using the retaining member 150 to secure the retaining member 150 and the drain body 120 to the enclosure. Examples of such coupling features can include, but are not limited to, mating threads, slots, and retractable protrusions. For example, the retaining member 150 can be threadably coupled to the drain body 120 using mating threads disposed on an interior surface of the retaining member wall 152 and on an outer surface of the drain wall 122.

In certain example embodiments, the optional sealing member 130 is positioned around the drain body 112, between the extending members 114 of the drain nut 110 and the retaining member 150. The sealing member 130 can include at least one wall 132 that forms a channel 131. The sealing member 130 can be used to create a seal between the retaining member 150 and another component (e.g., the drain body 112) and/or an enclosure. Such a seal can act as a barrier to prevent, or greatly reduce, dust, water, and/or other contaminants from entering the interior of the enclosure.

Examples of the sealing member 130 can include, but are not limited to, a gasket, an o-ring, and silicon gel. The sealing member 130 can be disposed within a feature (e.g., a recess, a channel) on the outer surface of the drain body 112, the retaining member 150, and/or an outer surface of the enclosure adjacent to the aperture through which the drain device traverses. For example, if the outer surface of the drain body 112 has a channel, then the sealing member 130 can be an o-ring that snugly fits within the channel. The sealing member 130 can be made of a compressible material. The sealing member 130 can be made from one or more of a number of materials, including but not limited to rubber, nylon, metal, and silicon.

In certain example embodiments, the optional drain net 140 mechanically couples to the bottom end 124 of the drain body 120 and/or a feature on the inner surface of the wall 152 of the retaining feature 150. The drain net 140 can include at least one wall 142 that forms a cavity 141. Mechanically coupled to one side-(e.g., the under side) of the wall 142 is a meshing 144. The meshing 144 can filter fluids that flow through the cavity 111 of the drain body 120 from inside the enclosure. The meshing 144 can be any type of filter, including but not limited to a mesh Screen and a sintered filter.

The various components (e.g., the retaining member 150, the drain body 120) of the drain device 100 can be made of the same and/or different materials compared to each other, in any case, however, the materials of the components of the drain device 100 can be sufficient to allow the drain device 100 to meet or exceed any standards and/or regulations that may apply to the enclosure to which the drain device 100 is coupled.

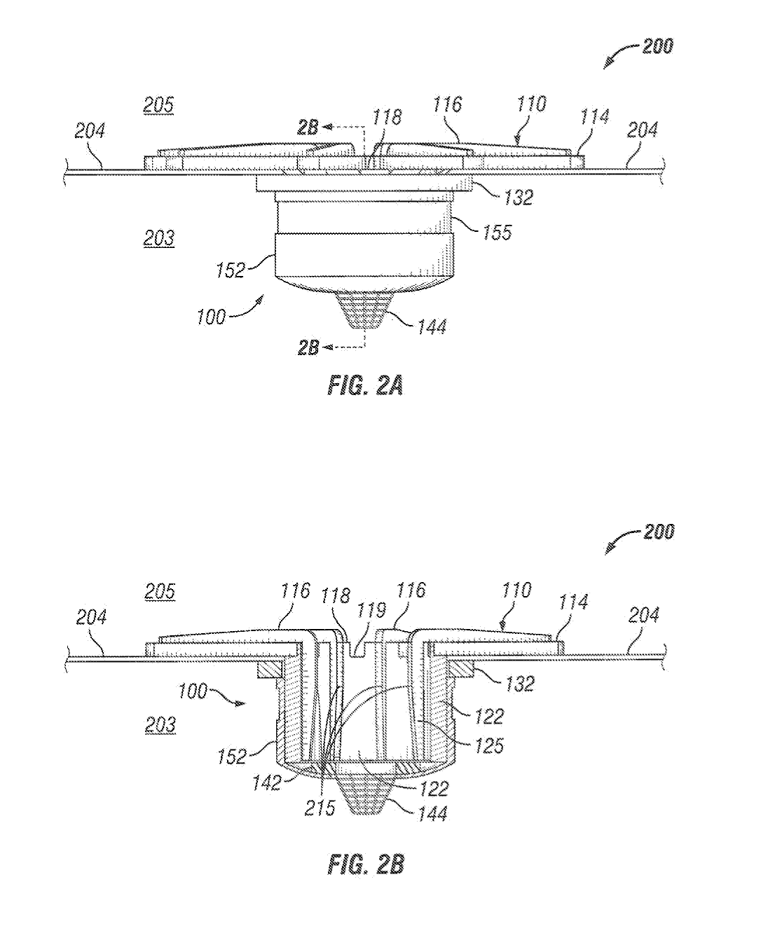

FIGS. 2A and 2B show various view of an enclosure 200 using the drain device 100, including the example drain nut 110, of FIGS. 1A and 1B in accordance with certain example embodiments. Specifically, FIG. 2A shows a side view of the enclosure 200, and FIG. 2B shows a cross-sectional side view of the enclosure 200. In one or more embodiments, one or more of the components shown in FIGS. 2A and 2B may be omitted, repeated, and/or substituted. Accordingly, embodiments of drain nuts should not be considered limited to the specific arrangements of components shown in FIGS. 2A and 2B,

Referring now to FIGS. 1A-2B. the drain device 100 of the enclosure 200 of FIGS. 2A and 28 includes the optional sealing member 130 and the drain net 140. The retaining member 150 and the drain body 120 in this example are threadably coupled to each other using mating threads disposed along the inner surface of the wall 152 of the retaining member 150 and along the outer surface of the drain wall 122 of the drain body 120. The sealing member 130 is positioned between the enclosure wall 204 and the retaining member 150, and the drain wail 122 of the drain body 120 traverses the channel 131 formed by the wall 132. In other words, the sealing member 130, the retaining member 150, and at least the bottom end 124 of the drain body 120 are positioned on the exterior 203 of the enclosure 200. In addition, the drain nut 110 and at least the top end 118 of the drain body 120 are positioned on the interior 205 of the enclosure 200.

As the threaded contact between the retaining member 150 and the drain body 120 is increased, the retaining member 150 presses upward into the sealing member 130 against the exterior surface of the enclosure wall 204. At the same time, the drain nut 110 (and in particular the extending members 114) are pressed downward against the interior surface of the enclosure wall 204 in such a case, the extending members 114 make contact with the interior surface of the enclosure wall 204, which allows fluids in the interior 205 of the enclosure 200 to better track, along the shape and/or features of the extending member 114, as described above.

In this case, the raised portions 116 protrude upward, from the top surface of the extending members 114. In addition, the inner surface of the drain wall 122 includes a number of vertical protrusions 125 that abut against the proximal end of the raised portions 116 at point 215, as shown in FIG. 2B. In addition, the lower edge of the gap 119 is on approximately the same plane as the interior surface of the enclosure wall 204.

FIGS. 3A and 3B show various views of another drain device 300 using an alternative drain nut 310 in accordance with certain example embodiments. Except as described below, the components of the drain device 300 are substantially similar to the corresponding components described above with respect to the drain device 100 of FIGS. 1A-2B. The different and/or additional features found in FIGS. 3A and 3B are described below.

Referring to FIGS. 1-3B, the drain body 320 of the drain device 300 is a separate piece from the drain nut 310. The drain body 320 has one or more drain walls 324 that form a cavity 321. Also, one end (here, the top end) can include a collar 322 or similar feature for mating against an optional sealing member 330 or (in the absence of a sealing member 330) an exterior surface of an enclosure wall (not shown). Here, the drain body 320 can have one or more mating features. For example, as shown in FIG. 3B, the drain body 320 can have a mating feature 326 disposed on the outer surface of the drain wall 324 and a different mating feature 329 on the inner surface of the drain wall 324. The mating features 326, 329 can be the same or different mating features. The mating features 326, 329 can be any type of mating feature, including (for example) mating threads as shown In FIGS. 3A and 3B.

Similarly, the retaining member 350 can have, multiple, mating features for mechanically coupling to the drain body 320 and/or one or more other components. In this case, a mating feature 356 disposed on the outer surface at the lower end of the wall 352, and a different mating feature 354 is disposed on the outer, surface at the upper end of the wall 352. In addition, a third mating feature 359 is disposed on the inner surface of the wall 352. The mating features 354, 356, 359 can be the same or different mating features. The mating features 354, 356, 359 can be any type of mating feature, including (for example) mating threads as shown in FIGS. 3A and 3B. One or more of the fastening features of the retaining member 350 can be used to mechanically couple the retaining member 350 to the drain body 320. In this example, the mating feature 359 (in this case, mating threads) disposed on the inner surface of the wall 352 can mate with the mating feature 326 (in this case, mating threads that, complement the mating feature 359) disposed on the outer surface of the drain wall 322 to mechanically couple the retaining member 350 to the drain body 320.

The drain nut 310 in this case includes a neck 312 that is mechanically coupled to the distal end of the extending members 314. The neck 312 can be used to mechanically couple the drain, nut 310 to the drain body 320. Specifically, the neck 312 can include one or more mating features disposed along the neck 312. For example, as shown in FIG. 3B, the neck 312 can have a mating feature (in this case, mating threads) disposed along the outer surface of the neck 312. The mating feature of the neck 312 can complement a corresponding mating feature (mating feature 329, in this case) that Is disposed on the drain wall 324 (in this case, along the inner surface of the drain wall 324 inside the cavity 321) of the drain body 320, When the drain nut 310 includes a neck 312, the neck 312 can traverse the aperture in the enclosure, as can the top end of the drain body 320. In this example, because of the collar 322 of the drain body is disposed at the top end of the drain body 320, the drain body 320 does not traverse the aperture in the enclosure.

In certain example embodiments, the drain nut 310 can be an adaptive device that replaces a component of an existing drain device 300. For example, the drain device 300 of FIGS. 3A and 3B could have originally included, in place of the example drain nut 310 shown, a different top component that mechanically couples to the drain body 320 using the same or a different fastening feature than the fastening feature shown on the neck 312. Such an original top component of the original drain device 300 can be removable, and so the example drain nut 310 can be used to replace the original top component of the drain device 300 with little effort exerted by a user. By allowing an existing drain device 300 to be modified by replacing an original component with the drain nut 310, costs in material and labor can be reduced because only one component, rather than the entire drain device 300, is replaced, in some eases, the adaptive drain nut 310 is simply added to, rather than replacing a portion of, the existing drain device 300.

In certain example embodiments, when the drain nut 310 is an adaptive device for an existing drain device 300, the drain nut 310 may not include a neck. In such a case, one or more of the extending members 314 can have a fastening feature (e.g., a clip, a tab) that is used to mechanically couple the drain nut 310 to the existing drain device 300. In certain example embodiments, the extending members 314 and/or the neck 312 (if any) of the drain nut 310 do not have any fastening features, and instead abut against an interior surface of an enclosure wall and/or a portion of an existing drain device 300 to provide enhanced liquid collection for the existing drain device 300.

In certain example embodiments, the extending members 314 and/or the optional neck 312 of the drain nut 310 can be arranged in one or more of a number of geometric shapes. Such a shape can include, but is not limited to, a circle, an oval, a square, a triangle, and an octagon, if a neck 312 is Included in the drain nut 310, the shape of the cross-sectional area of the neck 312 can be the same or different, than the shape in which the extending members 314 are arranged.

Example embodiments provide for a drain nut. Specifically, certain example embodiments allow for the collection of condensation and/or other fluids within an enclosure so that such condensation and/or other fluids can drain to an exterior of the enclosure. The extending members of the drain nut can provide a surface for hydrogen bonding and a path fox fluids to flow into the drain, taking advantage of the high surface energy of the beading fluids. Example embodiments can have varying sizes and shapes.

In addition, example embodiments provide for electrical and/or mechanical integrity of components and devices within an enclosure by reducing the corrosion and/or the occurrence of electrical faults and short circuits that can be caused by fluids, Specifically, using example drain nuts described herein reduce or eliminate the concern of moisture-related electrical problems associated with junction boxes, conduit, terminal blocks, fuse blocks, conductors, and a number of other components within enclosures. In addition, the use of example drain nuts can provide one or more of a number of electrical and/or mechanical benefits. Such benefits can include, but are not limited to, ease of installation, ease of maintenance, increased lifespan of electrical components associated with a conductor, and replacing a blown fuse that results from an overcurrent and/or fault condition brought on by fluid buildup within an enclosure.

Example drain nuts can be used as part of a new drain device. Alternatively, example embodiments can be adaptive drain nuts that are used in place of, or in addition to, at least a portion of an existing drain device for an enclosure. Example drain nuts can also include features (e.g., raised portions) that that increase the structural integrity and extend the useful life of the drain nut.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A drain device for an enclosure, the drain comprising:
a drain body comprising at least one wall forming a cavity, wherein the at least one wall traverses an aperture in the enclosure, and wherein the drain body has a top end positioned, inside the enclosure and a bottom end positioned outside the enclosure;
a drain, nut mechanically coupled to the top end of the drain body, wherein the drain nut comprises:
a plurality of extending members extending substantially radially away from the top end of the drain body,
wherein each extending member has a distal, end and a proximal end mechanically coupled to the top end of the drain body, and
wherein each extending member has a length that is greater than a width of the proximal end: and
a retaining member mechanically coupled to the bottom end of the drain body.

2. The drain device of claim 1, further comprising:
a sealing member positioned, between the outer surface of the enclosure and the retaining member.

3. The drain device of claim 2, further comprising:
a drain net mechanically coupled to the bottom end of the drain body, wherein the drain net comprises a meshing that filters fluids that flow through the cavity of the drain body from inside the enclosure.

4. The drain device of claim 1, wherein the retaining member is threadably coupled to the drain body using mating threads disposed on an interior surface of the retaining member and on an outer surface of the drain body.

5. The drain device of claim 1, wherein each extending member comprises a raised portion that extends along at least a portion of the extending member.

6. The drain device of claim 5, wherein the raised portion that extends along the length of the extending member and protrudes upward from a top surface of each extending member.

7. The drain device of claim 6, wherein the drain body further comprises an inner surface of the at least one wall and a plurality of vertical protrusions disposed on the at least one wall, wherein the plurality of vertical protrusions is a continuation of the raised portion on each of the plurality of extending members.

8. The drain device of claim 1, wherein each extending member is separated from an adjacent extending member by a gap.

9. The drain device of claim 8, wherein the gap is at a height that corresponds to an inner surface of the enclosure and the top end of the drain body.

10. The drain device of claim 1, wherein the width of the proximal end of each extending member is greater than another width of the distal end of such extending member.

11. The drain device of claim 1, wherein the drain nut further comprises a neck mechanically coupled to the distal end of the plurality of extending members, wherein the neck also mechanically couples to the at least one wall of the drain body.

12. The drain device of claim 11, wherein the drain body further comprises a third fastening feature, and wherein the neck of the drain nut is mechanically coupled to the drain body using a fourth fastening feature that complements the third fastening feature of the drain body.

13. The drain device of claim 12, wherein each of the first fastening feature, the second fastening feature, the third fastening feature, and the fourth fastening feature are mating threads.

14. An enclosure, comprising:
an enclosure wall having an aperture that traverses therethrough, wherein the enclosure wall separates an interior region and an exterior region; and
a drain device traversing the aperture and mechanically coupled to the enclosure wall, the drain device comprising:
a drain body comprising at least one wall forming a cavity, wherein the at least one wall traverses the aperture in the enclosure, wherein the drain body has a top end positioned In the interior region and a bottom end positioned in the exterior region;
a drain nut mechanically coupled to the top end of the drain body In the interior region, wherein the drain nut comprises:
a plurality of extending members extending substantially radially away from the top end of the drain body,
wherein each extending member has a distal end and a proximal end mechanically coupled to the top end of the drain body; and
wherein each extending member has a length that is greater than a width of the proximal end; and
a retaining member mechanically coupled to the. bottom end of the drain body in the exterior region.

15. The. enclosure of claim 14, wherein the drain nut further comprises a neck mechanically coupled to the distal end of the plurality of extending members, wherein the neck also mechanically couples to the at least one wall of the drain body.

16. The enclosure of claim 14, wherein each extending member comprises a raised portion that extends along at least a portion of the extending member.

17. The drain device of claim 14, wherein each extending member is separated from an adjacent extending member by a gap.

18. An adaptive drain nut, comprising:
a plurality of extending members arranged adjacent to each other in a geometric shape,
wherein each extending member has a proximal end mechanically coupled to at least one feature of an existing drain device,
wherein each extending member has a length that is greater than a width of the proximal end, and
wherein the existing drain device is mechanically coupled to an enclosure through an aperture in an enclosure wall.

19. The adaptive drain nut of claim 18, wherein the adaptive drain nut further comprises a neck that mechanically couples to the at least one feature of the existing drain device.

20. The adaptive drain nut of claim 18, wherein the plurality of extending members replaces at least one component of the existing drain device.
